(19) United States
(12) Patent Application Publication
(10) Pub. No.: US 2021/0164567 A1
(43) Pub. Date: Jun. 3, 2021

(54) Piston Ring Structure with Positioning Function

(71) Applicant: Cheng-Pei Lin, Taichung City (TW)

(72) Inventor: Cheng-Pei Lin, Taichung City (TW)

(21) Appl. No.: 16/701,232

(22) Filed: Dec. 3, 2019

(51) Int. Cl. F16J 9/18; F16J 9/28

(52) U.S. Cl. CPC F16J 9/18; F16J 9/28

(57) ABSTRACT

A piston ring structure includes a piston ring having an opening, and at least one positioning clip mounted on the opening of the piston ring. The at least one positioning clip is provided with two insertion slots corresponding to two sides of the opening. The at least one positioning clip is provided with a spacing rib located between the insertion slots. Each of the insertion slots of the at least one positioning clip are mounted on each of the two sides of the opening of the piston ring, with each of the two sides of the opening being inserted into each of the insertion slots of the at least one positioning clip.

### BACKGROUND OF THE INVENTION

### 1. Field of the Invention

The present invention relates to a ring structure and, more particularly, to a piston ring structure for a piston.

### 2. Description of the Related Art

A cylinder comprises a cylinder body, a piston movably mounted in the cylinder body, and a rod connected with the piston to drive and move the piston in the cylinder body reciprocatingly. A piston ring is mounted on the piston and located between the piston and the inner wall of the cylinder body, to reduce the friction between the piston and the cylinder body. The piston ring has a C-shaped configuration and defines an opening. After multiple piston rings are produced, the piston rings are stacked in pairs during packaging, to reduce the space of storage. However, the opening of each of the piston rings is not arranged in a flat manner, so that the piston rings are not secured steadily and easily deformed due to provision of the opening. In addition, the piston ring is mounted on the piston by experience of the operator, thereby decreasing the precision of installation of the piston ring.

### BRIEF SUMMARY OF THE INVENTION

The primary objective of the present invention is to provide a piston ring structure with a positioning function.

In accordance with the present invention, there is provided a piston ring structure comprising a piston ring having an opening, and at least one positioning clip mounted on the opening of the piston ring. The at least one positioning clip is provided with two insertion slots corresponding to two sides of the opening of the piston ring. The at least one positioning clip is provided with a spacing rib located between the two insertion slots. Each of the two insertion slots of the at least one positioning clip has a width flush with a thickness of the piston ring. Each of the two insertion slots of the at least one positioning clip are mounted on each of the two sides of the opening of the piston ring, with each of the two sides of the opening of the piston ring being inserted into each of the two insertion slots of the at least one positioning clip.

According to the primary advantage of the present invention, the at least one positioning clip fills the gap of the opening and secures the two sides of the opening, such that the piston ring is positioned in place steadily.

According to another advantage of the present invention, the at least one positioning clip clamps the piston ring efficiently, thereby preventing the piston ring from being deformed or distorted during packaging, transportation and storage.

According to a further advantage of the present invention, the at least one positioning clip keeps the opening at a flat state, to facilitate packaging, transportation and storage of the piston ring.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a piston ring structure in accordance with the preferred embodiment of the present invention.

FIG. 2 is an exploded perspective view of the piston ring structure in accordance with the preferred embodiment of the present invention.

FIG. 3 is a perspective view of a positioning clip of the piston ring structure in accordance with the preferred embodiment of the present invention.

FIG. 4 is a front planar view of the piston ring structure in accordance with the preferred embodiment of the present invention.

FIG. 5 is a top planar partial cross-sectional assembly view of the piston ring structure taken along line B-B as shown in FIG. 4.

FIG. 6 is a perspective view showing multiple piston rings are stacked.

### DETAILED DESCRIPTION OF THE INVENTION

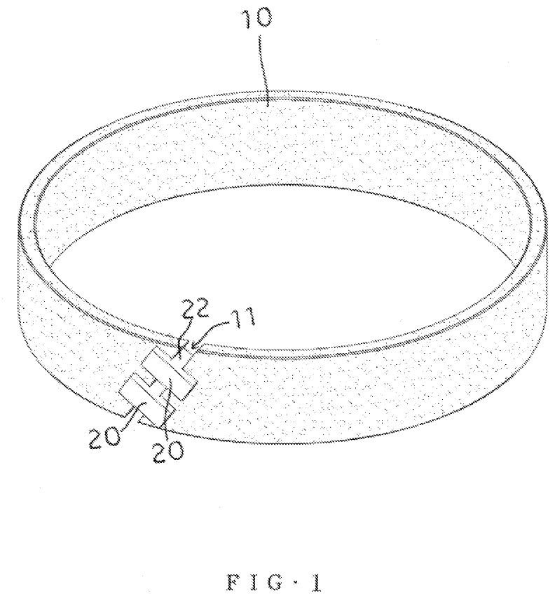

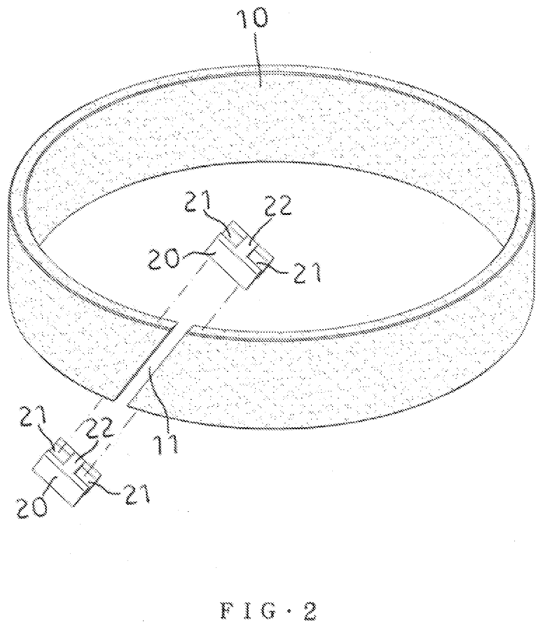

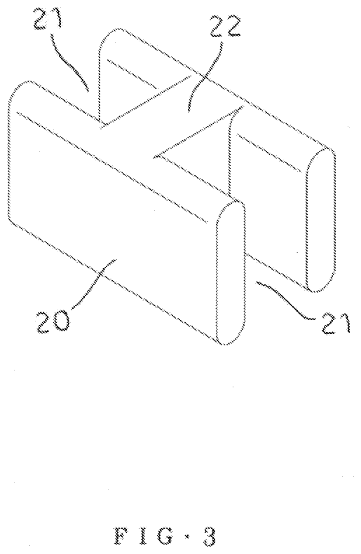

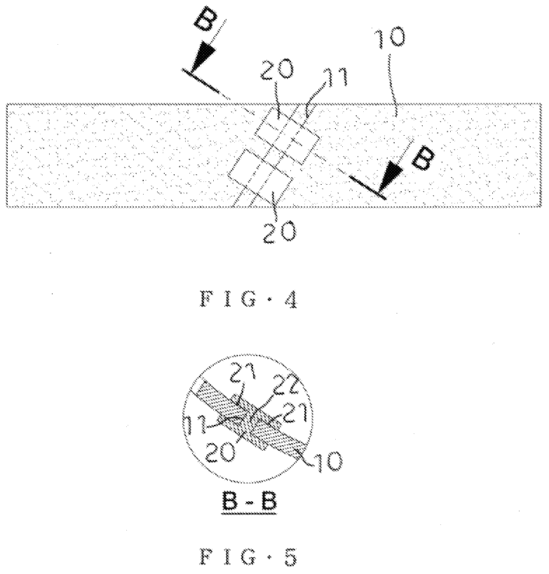

Referring to the drawings and initially to FIGS. 1-5, a piston ring structure in accordance with the preferred embodiment of the present invention comprises a piston ring (or directional ring or orienting ring or guide ring) 10 having an opening 11, and at least one positioning clip (or clamp or fastener) 20 mounted on the opening 11 of the piston ring 10.

The at least one positioning clip 20 is provided with two insertion slots 21 corresponding to two sides of the opening 11 of the piston ring 10. The at least one positioning clip 20 is provided with a spacing rib 22 located between the two insertion slots 21. Each of the two insertion slots 21 of the at least one positioning clip 20 has a width flush with a thickness of the piston ring 10. When each of the two insertion slots 21 of the at least one positioning clip 20 are mounted on each of the two sides of the opening 11 of the piston ring 10, each of the two sides of the opening 11 of the piston ring 10 is inserted into each of the two insertion slots 21 of the at least one positioning clip 20.

In the preferred embodiment of the present invention, the at least one positioning clip 20 is made of hard plastic material having H-shaped configuration.

In the preferred embodiment of the present invention, the two insertion slots 21 of the at least one positioning clip 20 are arranged symmetrically.

In practice, the piston ring 10 is used for a cylinder (including hydraulic cylinder and pneumatic cylinder) which includes a cylinder body, a piston movably mounted in the cylinder body, and a rod connected with the piston to drive and move the piston in the cylinder body. Thus, the piston is moved in the cylinder body reciprocatingly, to transmit a power. The piston ring 10 is located between the piston and the inner wall of the cylinder body, to prevent the piston and the cylinder body from producing metal contact rubbing, such that the piston does not directly contact with the cylinder body, thereby preventing from producing high temperature and metal fatigue due to frequent metal contact rubbing during the reciprocating operation of the piston, so as to enhance the working efficiency and the lifetime of the piston.

In the structural design of the piston ring 10, the piston ring 10 is easily mounted in an annular groove of the piston by provision of the opening 11. The piston ring 10 has an outer edge slightly protruding outward from the surface of the piston, such that when the piston is mounted in the cylinder body, the piston ring 10 fully contacts with the inner wall of the cylinder body. In such a manner, when the piston is moved in the cylinder body reciprocatingly, the piston will not touch the inner wall of the cylinder body by spacing of the piston ring 10, thereby preventing the piston from rubbing the cylinder body.

In fabrication, the at least one positioning clip 20 is mounted on the piston ring 10 after production of the piston ring 10, to position the piston ring 10 in place, thereby preventing the piston ring 10 from being deformed or distorted during packaging, transportation and warehousing. In addition, the at least one positioning clip 20 efficiently secures and maintains flatness (or level) of the opening 11 of the piston ring 10. Thus, the opening 11 of the piston ring 10 has a horizontal level and a length satisfying the standard of production of the piston ring 10,

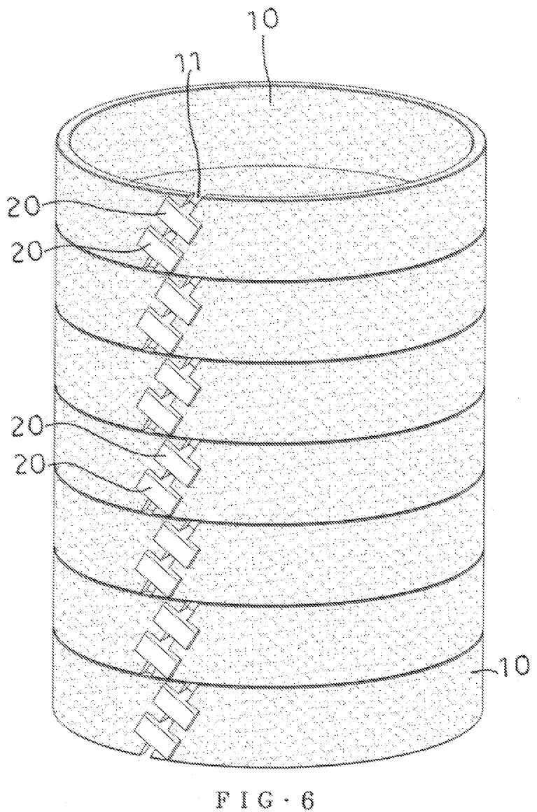

As shown in FIG. 6, the piston ring 10 is secured by the at least one positioning clip 20, such that when multiple piston rings 10 are stacked, the piston rings 10 will not be deformed during stacking, thereby facilitating packaging of the piston rings 10.

Accordingly, the at least one positioning clip 20 fills the gap of the opening 11 and secures the two sides of the opening 11, such that the piston ring 10 is positioned in place steadily. In addition, the at least one positioning clip 20 clamps the piston ring 10 efficiently, thereby preventing the piston ring 10 from being deformed or distorted during packaging, transportation and storage. Further, the at least one positioning clip 20 keeps the opening 11 at a flat state, to facilitate packaging, transportation and storage of the piston ring 10.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A piston ring structure comprising:
a piston ring having an opening; and
at least one positioning clip mounted on the opening of the piston ring;
wherein:
the at least one positioning clip is provided with two insertion slots corresponding to two sides of the opening of the piston ring;
the at least one positioning clip is provided with a spacing rib located between the two insertion slots;
each of the two insertion slots of the at least one positioning clip has a width flush with a thickness of the piston ring; and
each of the two insertion slots of the at least one positioning clip are mounted on each of the two sides of the opening of the piston ring, with each of the two sides of the opening of the piston ring being inserted into each of the two insertion slots of the at least one positioning clip.

2. The piston ring structure of claim 1, wherein the at least one positioning clip is made of hard plastic material having H-shaped configuration.

3. The piston ring structure of claim 1, wherein the two insertion slots of the at least one positioning clip are arranged symmetrically.
